(19) United States
(12) Patent Application Publication
(10) Pub. No.: US 2013/0313734 A1
(43) Pub. Date: Nov. 28, 2013

(54) METHOD OF PREVENTING AGGLOMERATION DURING MICROENCAPSULATION OF FRAGRANCE OILS

(71) Applicants: Peter C. Yao, Pickerington, OH (US); Clark A. Cook, Kingston, OH (US); Philip D. Rhoads, Waverly, OH (US)

(72) Inventors: Peter C. Yao, Pickerington, OH (US); Clark A. Cook, Kingston, OH (US); Philip D. Rhoads, Waverly, OH (US)

(73) Assignee: P. H. GLATFELTER COMPANY, York, PA (US)

(21) Appl. No.: 13/477,348

(22) Filed: May 22, 2012

(51) Int. Cl. B01J 13/16

(52) U.S. Cl. 264/4.7

(57) ABSTRACT

A process for preparing a microcapsules comprising an oil-based core material such that particle agglomeration is minimized during wall formation, the process employs reaction of an isocyanate or diisocyanate first with a guanidine compound followed by reaction with a polyfunctional amine.

### BACKGROUND OF THE INVENTION

The present invention provides a process for forming microencapsulated oil-based materials such as fragrance oils. In particular, the present invention provides a process for minimizing or eliminating agglomeration of polyurea microcapsules during their formation in an interfacial polymerization technique.

The background of the present invention will be described in connection with its use in connection with encapsulation of fragrances. It should be understood, however, that the use of the present invention has wider applicability as described hereinafter. There are almost limitless applications for microencapsulated materials. For example, microencapsulated materials are utilized in agriculture, pharmaceuticals, foods (e.g., flavor delivery), cosmetics, laundry, textiles, paper, paints, coatings and adhesives, printing applications, and many other industries.

Microencapsulation is a process in which tiny particles or droplets are surrounded by a coating to create small capsules around the droplets. Thus, in a relatively simplistic form, a microcapsule is a small sphere with a uniform wall around it. The substance that is encapsulated may be called the core material, the active ingredient or agent, fill, payload, nucleus, or internal phase. The material encapsulating the core is referred to as the coating, membrane, shell, or wall material. Microcapsules may have one wall or multiple shells arranged in strata of varying thicknesses around the core. Most microcapsules have diameters between 1 μm and 100 μm.

Microencapsulation has been employed as a means to protect fragrances or other active agents from, for example, oxidation caused by heat, light, humidity, and exposure to other substances over their lifetime. Microencapsulation has also been used to prevent evaporation of volatile compounds and to control the rate of release by many actions such as, for example, mechanical, temperature, diffusion, pH, biodegradation, and dissolution means.

Microencapsulation may be achieved by a myriad of techniques, with several purposes in mind. Substances may be microencapsulated with the intention that the core material be confined within capsule walls for a specific period of time. Alternatively, core materials may be encapsulated so that the core material will be released either gradually through the capsule walls, known as controlled release or diffusion, or when external conditions trigger the capsule walls to rupture, melt, or dissolve.

A preferred microencapsulation means in the context of the present invention involves an interfacial polymerization employing an oil-in-water emulsion. Interfacial polymerization (IFP) is characterized by wall formation via the rapid polymerization of monomers at the surface of the droplets or particles of dispersed core material. A multifunctional monomer is dissolved in the core material, and this solution is dispersed in an aqueous phase. A reactant to the monomer is added to the aqueous phase, and polymerization quickly ensues at the surfaces of the core droplets, forming the capsule walls. IFP can be used to prepare bigger microcapsules depending on the process, but most commercial IFP processes produce smaller capsules in the 20-30 μm or even smaller, for example, 3-6 μm.

Fragrances and perfumes, in general, possess terminal groups such as —OH, —NH, —C═O, —CHO, or —COOH. Their partial solubility in water leads to great instability in the microencapsulation interfacial polymerization reactions. These chemical groups tend to surround the wall of the microcapsule, modifying the hydrolytic stability of the particle and destabilizing the polymerization reaction. Moreover, these groups can react with the monomers during interfacial polymerization, leading to microcapsule formation that might modify the properties of fragrances and perfumes.

These problems with encapsulating fragrances have been at least partially rectified by employing polyurea systems to form the shell of the microcapsule. Another benefit to using polyurea systems is their versatility in that they can be tailor-made from a wide range of raw materials in order to achieve the desired chemical and mechanical properties.

Microcapsules having walls made of polyurea are prepared by a two-phase polyaddition process. To this end, an oil phase containing an organic water-immiscible inert solvent, polyisocyanate and the material to be encapsulated is emulsified in an aqueous phase containing water and, if desired, additives such as emulsifiers, stabilizers and/or materials for preventing coalescence. The addition of a polyamine or an amino alcohol to this emulsion initiates a polyaddition reaction of amino and/or hydroxyl groups with isocyanate groups at the interface between oil droplets and water phase. As a result thereof, the oil droplets are enveloped by a polyurea or polyurea/polyurethane wall. This gives a dispersion of microcapsules containing the material to be encapsulated and the organic solvent. The size of the microcapsules is approximately equal to the size of the emulsified oil droplets.

Polyurea interfacial polymerization, however, is not without its challenges. For example, for encapsulating fragrance oils, a preferred cross-linker during the formation of the shell is diethylene triamine because this cross-linker contributes to the formation of an impermeable wall due to the higher functionality of diethylene triamine. However, during such reactions, it is difficult to prevent agglomeration of the fragrance encapsulated polyurea particles leading to particles that are too large for their intended use. Accordingly, there is a need in the art for a process to prepare polyurea/diethylene triamine encapsulated fragrance oils that allows for good control of the particle size of the capsules.

### BRIEF SUMMARY OF THE INVENTION

The present invention satisfies this need by providing a process that employs guanidine carbonate during the initial stages of polymerization. In one aspect, the present invention provides process for preparing microcapsules comprising an oil-based core material such that particle agglomeration is minimized during wall formation, the process comprising the steps of: mixing at least one first prepolymer with an oil-based core material, wherein the prepolymer is selected from the group consisting of an isocyanate, a diisocyanate, and a mixture thereof; dissolving at least one second prepolymer in water to form a second prepolymer aqueous solution, wherein the at least one second prepolymer is an amine having at least two function groups; dissolving a guanidine compound in water to form an aqueous guanidine solution, wherein the guanidine compound has at least two functional groups; adding the mixture of the oil-based core material and the at least one first prepolymer to water and forming an emulsion; adding the aqueous guanidine solution to the emulsion to initiate polymerization with the at least one first prepolymer under agitation at a temperature of from about 60° C. to 80° C. thus forming pre-microcapsules having at least one layer of a first polymeric shell around the oil-based core material; adding the second prepolymer aqueous solution to the emulsion to initiate polymerization with the at least one first prepolymer under agitation at a temperature of from about 60° C. to 80° C. thus forming the microcapsules; and cooling the microcapsules, wherein the guanidine compound is added from 10 to 80 equivalent % of the at least one first prepolymer and the at least one second prepolymer reacts with the remaining equivalents.

### BRIEF DESCRIPTION OF THE DRAWINGS

FIG. 1 is a table showing the results of the experimental work described in the Examples.

### DETAILED DESCRIPTION OF THE INVENTION

The present invention provides a process for preparing microcapsules comprising an oil-based core material such that particle agglomeration is minimized during wall formation, the process comprising the steps of: mixing at least one first prepolymer with an oil-based core material, wherein the prepolymer is selected from the group consisting of an isocyanate, a diisocyanate, and a mixture thereof; dissolving at least one second prepolymer in water to form a second prepolymer aqueous solution, wherein the at least one second prepolymer is an amine having at least two function groups; dissolving a guanidine compound in water to form an aqueous guanidine solution, wherein the guanidine compound has at least two functional groups; adding the mixture of the oil-based core material and the at least one first prepolymer to water and forming an emulsion; adding the aqueous guanidine solution to the emulsion to initiate polymerization with the at least one first prepolymer under agitation at a temperature of from about 60° C. to 80° C. thus forming pre-microcapsules having at least one layer of a first polymeric shell around the oil-based core material; adding the second prepolymer aqueous solution to the emulsion to initiate polymerization with the at least one first prepolymer under agitation at a temperature of from about 60° C. to 80° C. thus forming the microcapsules; and cooling the microcapsules, wherein the guanidine compound is added from 10 to 80 equivalent % of the at least one first prepolymer and the at least one second prepolymer reacts with the remaining equivalents.

The process of the present invention includes the step of forming a hydrophobic or oil phase of an emulsion by mixing at least one first prepolymer with an oil-based core material, wherein the first prepolymer is selected from the group consisting of an isocyanate, a diisocyanate, and a mixture thereof. Preferably, according to the present invention the oil-based core is a fragrance oil to be encapsulated by the process. As used herein, the term “fragrance oil” includes perfumes and a variety of fragrance materials of both natural and synthetic origins whose scent is recognized by a person of ordinary skill in the art as being able to impart or modify in a positive or pleasant way the odor of a composition. Fragrance oils may include single compounds and mixtures of compounds. Specific examples of such compounds include perfuming ingredients belonging to varied chemical groups such as alcohols, aldehydes, ketones, esters, acetates, nitrites, terpenic hydrocarbons, heterocyclic nitrogen- or sulfur-containing compounds, as well as natural or synthetic oils.

Examples of fragrance oils useful herein include, but are not limited to, animal fragrances such as musk oil, civet, castoreum, ambergris, plant fragrances such as nutmeg extract, cardomon extract, ginger extract, cinnamon extract, patchouli oil, geranium oil, orange oil, mandarin oil, orange flower extract, cedarwood, vetyver, lavandin, ylang extract, tuberose extract, sandalwood oil, bergamot oil, rosemary oil, spearmint oil, peppermint oil, lemon oil, lavender oil, citronella oil, chamomille oil, clove oil, sage oil, neroli oil, labdanum oil, eucalyptus oil, verbena oil, mimosa extract, narcissus extract, carrot seed extract, jasmine extract, olibanum extract, rose extract and mixtures thereof.

Other examples of suitable fragrance oils include, but are not limited to, chemical substances such as acetophenone, adoxal, aldehyde C-12, aldehyde C-14, aldehyde C-18, allyl caprylate, ambroxan, amyl acetate, dimethylindane derivatives, .alpha.-amylcinnamic aldehyde, anethole, anisaldehyde, benzaldehyde, benzyl acetate, benzyl alcohol and ester derivatives, benzyl propionate, benzyl salicylate, borneol, butyl acetate, camphor, carbitol, cinnamaldehyde, cinnamyl acetate, cinnamyl alcohol, cis-3-hexanol and ester derivatives, cis-3-hexenyl methyl carbonate, citral, citronnellol and ester derivatives, cumin aldehyde, cyclamen aldehyde, cyclo galbanate, damascones, decalactone, decanol, estragole, dihydromyrcenol, dimethyl benzyl carbinol, 6,8-dimethyl-2-nonanol, dimethyl benzyl carbinyl butyrate, ethyl acetate, ethyl isobutyrate, ethyl butyrate, ethyl propionate, ethyl caprylate, ethyl cinnamate, ethyl hexanoate, ethyl valerate, ethyl vanillin, eugenol, exaltolide, fenchone, fruity esters such as ethyl 2-methyl butyrate, galaxolide, geraniol and ester derivatives, helional, 2-heptonone, hexenol, α-hexylcinnamic aldehyde, hydroxycitrolnellal, indole, isoamyl acetate, isoeugenol acetate, ionones, isoeugenol, isoamyl iso-valerate, limonene, linalool, lilial, linalyl acetate, lyral, majantol, mayol, melonal, menthol, p-methylacetophenone, methyl anthranilate, methyl cedrylone, methyl dihydrojasmonate, methyl eugenol, methyl ionone, methyl-β-naphthyl ketone, methylphenylcarbinyl acetate, mugetanol, γ-nonalactone, octanal, phenyl ethyl acetate, phenyl-acetaldehyde dimethyl acetate, phenoxyethyl isobutyrate, phenyl ethyl alcohol, pinenes, sandalore, santalol, stemone, thymol, terpenes, triplal, triethyl citrate, 3,3,5-trimethylcyclohexanol, γ-undecalactone, undecenal, vanillin, veloutone, verdox and mixtures thereof. Preferred fragrance oils for use according to the present invention include limonene, and various commercial blends such as, for example, APRIL FRESH™ fragrance oil (available from Arylessence, Marietta, Ga.) and FLORACAPS FRESH™ (available from Colgate-Palmolive Company, Bois Colombes, France).

As used herein, the term “prepolymer” refers to a chemical component that is capable of reacting with at least one other prepolymer or another of its kind as to enable formation of the polymer. Because the present invention is primarily directed to polyurea or polyurethane containing microcapsule shells, the at least one first prepolymer according to the present invention is selected from the group consisting of an isocyanate, a diisocyanate, and a mixture thereof. According to an embodiment of the present invention, the at least one first prepolymer is a C₈₋₂₀ bis-isocyanate. Specific but non-limiting examples of such bis-isocyanates include isophorone diisocyanate (IPDI), hexamethylene diisocyanate (HMDI) or its dimer or trimer, toluene diisocyanate, and bis(4-isocyanatocyclohexyl)methane, and mixtures thereof.

The process of the present invention includes the step of forming an aqueous phase of an emulsion by dissolving at least one second prepolymer in water to form a second prepolymer aqueous solution, wherein the at least one second prepolymer is an amine having at least two function groups. The second prepolymer may also be referred to herein as a “cross linker.” Suitable such amines include aliphatic primary, secondary, or tertiary amines such as 1,2-ethylene diamine, bis-(3-aminopropyl)-amine, hydrazine, hydrazine-2-ethanol, bis-(2-methylaminoethyl)-methyl amine, 1,4-diaminocyclohexane, 3-amino-1-methylaminopropane, N-hydroxyethyl ethylene diamine, N-methyl-bis-(3-aminopropyl)-amine, 1,4-diamino-n-butane, 1,6-diamino-n-hexane, 1,2-ethylene diamine-N-ethane sulphonic acid (in the form of an alkali metal salt), 1-aminoethyl-1,2-ethylene diamine or bis-(N,N′-aminoethyl)-1,2-ethylene diamine, and diethylenetriamine. Hydrazine and its salts are also regarded as diamines in the present context. The following polyisocyanates are particularly preferred and include hexamethylene diisocyanate, isophorone diisocyanate and/or derivatives of hexamethylene diisocyanate and of isophorone diisocyanate having free isocyanate groups, and mixtures thereof.

The process of the present invention includes the step of dissolving a guanidine compound in water to form an aqueous guanidine solution, wherein the guanidine compound has at least two functional groups. Examples of guanidine compounds which are suitable for preparing the microcapsules according to the invention are those of the formula (I)

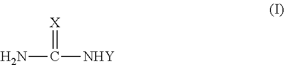

in which X represents HN═,

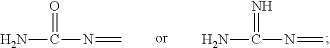

and Y represents H—, NC—, H₂N—, HO—,

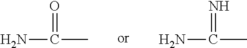

and salts thereof with acids.

For example, the salts can be salts of carbonic acid, nitric acid, sulphuric acid, hydrochloric acid, silicic acid, phosphoric acid, formic acid and/or acetic acid. Salts of guanidine compounds of the formula (I) can be used in combination with inorganic bases in order to obtain the free guanidine compounds of the formula (I) in situ from the salts. Examples of inorganic bases which are suitable for this purpose are alkali metal hydroxides and/or alkaline earth metal hydroxides and/or alkaline earth metal oxides. Preference is given to aqueous solutions or slurries of these bases, in particular to aqueous sodium hydroxide solution, aqueous potassium hydroxide solution and aqueous solutions or slurries of calcium hydroxide. Combinations of a plurality of bases can also be used.

It is often advantageous to use the guanidine compounds of the formula (I) as salts because they are commercially available in this form and some of the free guanidine compounds are sparingly soluble in water or are not stable on storage. If inorganic bases are used, they can be employed in stoichiometric, less than stoichiometric and more than stoichiometric amounts, relative to the salts of guanidine compounds. It is preferred to use 10 to 100 equivalent % of inorganic base (relative to the salts of guanidine compounds). The addition of inorganic bases has the effect that during microencapsulation guanidine compounds having free NH₂ groups are available in the aqueous phase for the reaction with the polyisocyanates present in the oil phase. During microencapsulation, the addition of salts of guanidine compounds and of bases is advantageously carried out such that they are added separately to the aqueous phase.

Preference is given to the use of guanidine or salts of guanidine with carbonic acid, nitric acid, sulphuric acid, hydrochloric acid, silicic acid, phosphoric acid, formic acid and/or acetic acid.

It is particularly advantageous to use salts of guanidine compounds with weak acids. In aqueous solution these salts are, as a result of hydrolysis, in equilibrium with the corresponding free guanidine compound. The free guanidine compound is consumed during the encapsulation process but is constantly regenerated in accordance with the law of mass action. This advantage is especially observed with guanidine carbonate. When salts of guanidine compounds with weak acids are used, no inorganic bases for releasing the free guanidine compounds need to be added.

Guanidine carbonate is the preferred guanidine compound for use in accordance with the present invention.

The guanidine compounds of the formula (I) which are suitable for the present invention can be prepared by ion exchange from their water-soluble salts by prior art methods using commercially available basic ion exchangers. The eluate from the ion exchanger can be used directly for producing the capsule wall by mixing it with the oil-in-water emulsion.

The concentration of guanidine compound in the aqueous guanidine solutions of the present invention is not critical and is in general only limited by the solubility of the guanidine compounds in water. For example, 1 to 20% strength by weight aqueous solutions of guanidine compounds are suitable.

The process of the present invention includes the step of adding the mixture of the oil-based core material and the at least one first prepolymer to water and forming an emulsion. To produce the microcapsules, the oil phase comprising the at least one first prepolymer (e.g., diisocyanate) and the oil-based core material (e.g., fragrance oil) are mixed with water and emulsified in an aqueous phase which may also contain one or more protective colloids and emulsification aids in the aqueous phase to stabilize the emulsion. Examples of products which act as protective colloids are carboxy methyl cellulose, gelatin and polyvinyl alcohol. Examples of suitable emulsifiers are ethoxylated 3-benzyl hydroxy biphenyl, reaction products of nonyl phenol with different quantities of ethylene oxide and sorbitan fatty acid esters. The amount of such additives can, for example, range from 0 to 2% by weight, relative to the particular phase. If desired, the oil phase may also contain emulsifiers.

The emulsion can be made by any method known to those skilled in the art. For example, once all of the ingredients for making the emulsion are admixed, the resulting emulsion or combination of ingredients may be run through a homogenizer. The homogenizer total stage pressure may be from about 1 psig to about 30,000 psig (about 7 kPa to about 206850 kPa), generally at least about 2,000 psig (13790 kPa), preferably from about 4,000 psig to about 10,000 psig (about 27580 kPa to about 68950 kPa), most preferably from about 5,000 psig to about 7,000 psig (about 34475 kPa to about 48265 kPa). The homogenization may be performed in one or more stages, using one or more passes through each stage. For example, two stages and three passes may be employed for the homogenization step. In other embodiments, there may be as many as four discrete passes of the emulsion through the homogenizer, but more preferably there are two to three passes. This process can produce a stable emulsion with droplet sizes less than about 2.1 microns (90 percentile), preferably less than about 1 micron (90 percentile). It is preferable to minimize heat exposure during homogenization as much as possible and to keep a nitrogen blanket on all emulsion containers.

The process of the present invention includes the step of adding the aqueous guanidine solution to the emulsion to initiate polymerization with the at least one first prepolymer under agitation at a temperature of from about 60° C. to 80° C. thus forming pre-microcapsules having at least one layer of a first polymeric shell around the oil-based core material. As used herein, the term “pre-microcapsules” refers to an intermediate microcapsule of the present invention where only the guanidine compound has been added to cross-link with the at least one first prepolymer such that there is a substantial amount of unreacted NCO groups that remain to be reacted in the at least one first prepolymer. It was surprisingly discovered that particle agglomeration during the wall formation polymerization step could be significantly reduced if not eliminated altogether if from about 10% to about 80% and, preferably, from about 10% to about 50%, of the stoichiometry needed to fully react with the isocyanate prepolymer is derived from the guanidine compound followed by the addition of the amine after reaction of the guanidine is complete. In one embodiment of the present invention, 10% of a guanidine compound is employed. In another embodiment of the present invention, 15% of a guanidine compound is employed. In another embodiment of the present invention, 20% of a guanidine compound is employed. In another embodiment of the present invention, 25% of a guanidine compound is employed. In yet another embodiment of the present invention, 30% of a guanidine compound is employed. In yet another embodiment of the present invention, 35% of a guanidine compound is employed. In yet another embodiment of the present invention, 40% of a guanidine compound is employed. In still another embodiment of the present invention, 45% of a guanidine compound is employed. In still another embodiment of the present invention, 50% of a guanidine compound is employed. In still another embodiment of the present invention, 60% of a guanidine compound is employed. In still another embodiment of the present invention, 70% of a guanidine compound is employed. In yet another embodiment of the present invention, 80% of a guanidine compound is employed.

Although reaction between the guanidine compound and the at least one first polymer occurs on contact, the mixture is preferably heated to from about 60° C. to about 80° C. under agitation because heat also serves the process as a catalyst. Preferably, the reaction is held at this temperature for at least two hours.

It is understood that the polymerization reaction is performed on the emulsion and that the emulsion has to be maintained as such for the time needed to carry out the polymerization reaction. Thus the emulsion must be sufficiently stable by employing chemical aids and/or strong mechanical stirring.

Once the aqueous guanidine solution has been added and the guanidine compound has reacted with the at least one first prepolymer, the process of the present invention includes the step of adding the second prepolymer aqueous solution to the emulsion to initiate polymerization with the at least one first prepolymer under agitation at a temperature of from about 60° C. to 80° C. thus forming the microcapsules. The amount of the second prepolymer should be sufficient to react with the remaining NCO groups of the first prepolymer. This reaction step, like the prior step, is preferably heated to from about 60° C. to about 80° C. under agitation for at least two hours.

During the polymerization process the particle size of the forming microcapsules is dependent on the particle size of the emulsion made prior to the addition of cross-linker. This, of course, depends on the amount of mechanical energy added to the system as well as on the chemical stabilizers employed as will be recognized by those skilled in the art.

Without intending to be bound by a particular theory, it is believed that when the guanidine compound is added first during the initial stages of wall formation a thin layer of a polymeric shell is formed and provides a more stable particle because the guanidine compound reacts quickly and completely and hardens and, thus, is less “sticky” during wall formation. Reaction with the amine prepolymer subsequently occurs when the amine migrates into the formed shell and reacts internal to the shell thus building the shell from the outside inwards.

The process of the present invention also includes the step of cooling the microcapsules. Once the reaction is complete, the microcapsule-containing mixture can be allowed to cool to, for example, room temperature by simply removing the heat source or via a heat exchanger device known to those skilled in the art.

Microcapsules according to the invention can be produced by continuous and batchwise methods. The continuous procedure can be such, for example, that an emulsion of the desired type and oil droplet size is produced continuously in an emulsifying machine by the flow-through method. This can be followed by continuous addition of an aqueous solution of a guanidine compound followed by the amine in a downstream reaction vessel.

The batchwise procedure can be such, for example, that the aqueous guanidine solution followed by the amine as detailed above is added to an emulsion containing oil droplets having approximately the size of the desired microcapsules at the desired temperature. In such an amount as is required stoichiometrically for the reaction of all isocyanate groups present in the oil phase. If the guanidine compounds are available as salts, first an aqueous solution of the particular salt can, if desired, be run through an anion exchanger to give an aqueous solution of the free guanidine compound which is then used. It is assumed that all NH₂ groups present in guanidine compounds or obtained from salts of guanidine compounds are capable of reacting with NCO groups. It is assumed that one mole of guanidine and guanidine salts (formula (I), X is NH, Y is H) can react with 2 mol of NCO groups.

The components of the emulsion can be mixed together in various ratios. According to one embodiment of the invention, the oil-based core material may account for between 30 and 95%, more preferably for between 60 and 90%, of the total weight of the dry capsules obtained by the process of the present invention.

The microcapsules of the present invention possess a number of advantages. By varying the amount of guanidine compound and amine and the order of adding the reactants as detailed above, a layering technique can be employed to optimize microcapsule performance with conflicting property requirements such as the need for different flexibilities and impermeabilities.

The following examples are provided for the purpose of further illustrating the present invention but are by no means intended to limit the same.

### EXAMPLES

### Preparation of External Phase (EP) (Shell)

228.5 grams of distilled water were added to a 600-mL glass beaker. The beaker was placed on laboratory hot plate with a magnetic stirrer. 2.3 grams of polyvinyl alcohol (Celvol 523) were added into the distilled water under heat and agitation until dissolved. The mixture was cooled and set aside.

### Preparation of Internal Phase (IP)

152.7 grams of fragrance oil (Floracaps Fresh (#29058) Supplied by Colgate Palmolive) was added to a separate 600-mL glass beaker. 38.2 grams of polyisocyanate were added into the oil under and agitation until a uniform mixture was obtained. The mixture was set aside.

### Preparation of Polyamine Solution

Referring to Tables 1 and 2 below, separate solutions of guanidine carbonate (GUCA) and diethylenetriamine (DETA) at varying concentrations were prepared in distilled water under agitation.

### Preparation of Emulsion

IP was slowly added to the EP and emulsified to 15 μm to 30 μm diameter emulsion using a laboratory homogenizer (ULTRA-TURRAX T-50, manufactured by IKA) at 3,500 rpm for 30 seconds.

### Microcapsule Wall Formation

The guanidine carbonate solution was added to the emulsion under agitation using an overhead laboratory mixer (IKA RW-16 Basic) and the temperature was gradually increased temperature to from about 60 to 80° C. and held for 2 hours. Note that batch #2 did not required guanidine carbonate. The diethylenetriamine solution was then gradually added to the batch and held for another 3 to 4 hours. Heat was removed and mixing continued until the batch cooled to room temperature. 0.3% of a suspension aid (Cellulon PX) was added to prevent creaming and phase separation.

TABLE 1
GUCA Solution

| | Batch 2 | Batch 5 | Batch 6 | Batch 7 | Batch 8 | Batch 4 |
|---|---|---|---|---|---|---|
| GUCA | — | 2.1 | 4.1 | 6.2 | 8.2 | 10.3 |
| Water | — | 11.7 | 23.4 | 35.0 | 46.7 | 41.2 |
| Total | — | 13.7 | 27.5 | 41.2 | 55.0 | 51.5 |

TABLE 2
DETA Solution

| | Batch 2 | Batch 5 | Batch 6 | Batch 7 | Batch 8 | Batch 4 |
|---|---|---|---|---|---|---|
| DETA | 11.8 | 10.6 | 9.4 | 8.3 | 7.1 | 5.9 |
| Water | 47.2 | 60.2 | 53.5 | 46.8 | 40.1 | 23.6 |
| Total | 59.0 | 70.8 | 62.9 | 55.0 | 47.2 | 29.5 |

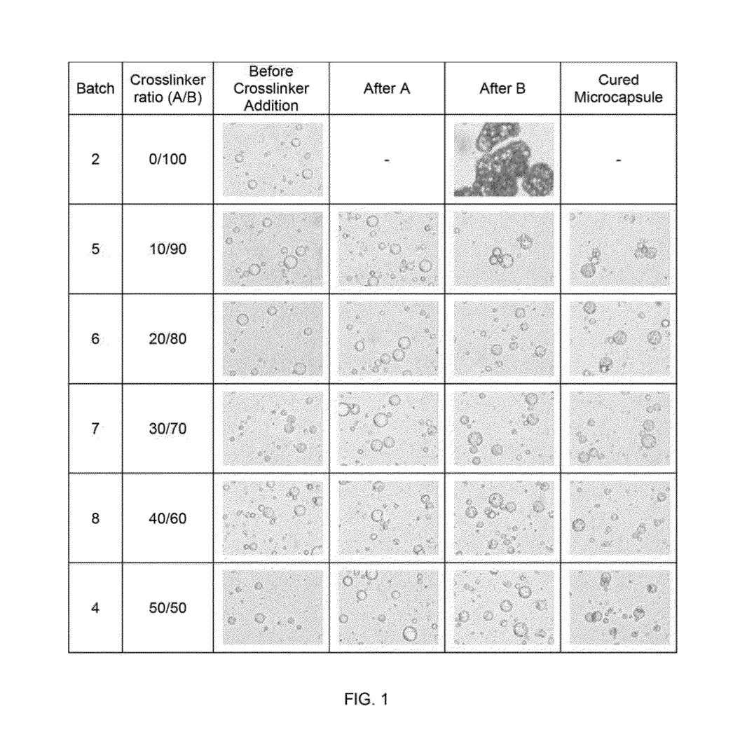

Referring to FIG. 1, through the addition of as little as 10% guanidine carbonate during the initial stage of the wall formation and allowing sufficient time for the guanidine carbonate to form a thin layer of shell, agglomeration was reduced substantially in subsequent diethylene triamine crosslinking. Referring to FIG. 1, the fragrance oil was Floracaps Fresh (#29058) Supplied by Colgate Palmolive, the isocyanate was EXPN 2294 IPDI Supplied by Kemira, crosslinker A was guanidine carbonate, and crosslinker B was Diethylenetriamine.

The above procedure also demonstrates that agglomeration of the microcapsules during wall formation can be minimized by utilization of a layered shell works best. In this regard, polyurea microcapsules crosslinked with guanidine carbonate are less susceptible to agglomeration but are more prone to leakage of the fragrance oil. On the other hand, microcapsules crosslinked with diethylene triamine are expected to provide a relatively more impermeable wall due to the higher functionality of the crosslinker. Thus, the above procedure demonstrates that agglomeration during wall formation can be prevented by employing this technique and also to optimize microcapsule performance with conflicting property requirements such as, for example, the need for flexibility and impermeability, with the use of crosslinkers (e.g., polyamines) that provide dissimilar equivalent weights and/or aliphatic/aromatic functionalities.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

1. A process for preparing microcapsules comprising an oil-based core material such that particle agglomeration is minimized during wall formation, the process comprising the steps of:
a) mixing at least one first prepolymer with an oil-based core material, wherein the prepolymer is selected from the group consisting of an isocyanate, a diisocyanate, and a mixture thereof;
b) dissolving at least one second prepolymer in water to form a second prepolymer aqueous solution, wherein the at least one second prepolymer is an amine having at least two function groups;
c) dissolving a guanidine compound in water to form an aqueous guanidine solution, wherein the guanidine compound has at least two functional groups;
d) adding the mixture of the oil-based core material and the at least one first prepolymer to water and forming an emulsion;
e) adding the aqueous guanidine solution to the emulsion to initiate polymerization with the at least one first prepolymer under agitation at a temperature of from about 60° C. to 80° C. thus forming pre-microcapsules having at least one layer of a first polymeric shell around the oil-based core material;
f) adding the second prepolymer aqueous solution to the emulsion to initiate polymerization with the at least one first prepolymer under agitation at a temperature of from about 60° C. to 80° C. thus forming the microcapsules; and
g) cooling the microcapsules,
wherein the guanidine compound is added from 10 to 80 equivalent % of the at least one first prepolymer and the at least one second prepolymer reacts with the remaining equivalents.

2. The process of claim 2 further comprising the step of adding a suspension aid to prevent phase separation of the emulsion.

3. The process of claim 1 wherein the emulsion further includes poly(vinyl alcohol) prior to addition of the aqueous guanidine solution.

4. The process of claim 1 wherein the guanidine compound is guanidine carbonate.

5. The process of claim 1 wherein the oil-based core material is a fragrance oil.

6. The process of claim 1 wherein the at least one first prepolymer is selected from the group consisting of an isocyanate, a diisocyanate, and a mixture thereof.

7. The process of claim 6 wherein the at least one first prepolymer is a C₈₋₂₀ bis-isocyanate.

8. The process of claim 1 wherein the C₈₋₂₀ bis-isocyanates is selected from the group consisting of isophorone diisocyanate (IPDI), hexamethylene diisocyanate (HMDI) or its dimer or trimer, toluene diisocyanate, bis(4-isocyanatocyclohexyl)methane, and mixtures thereof.

9. The process of claim 8 wherein the C₈₋₂₀ bis-isocyanates comprises isophorone diisocyanate (IPDI).

10. The process of claim 8 wherein the C₈₋₂₀ bis-isocyanates comprises hexamethylene diisocyanate (HMDI) or its dimer or trimer.

11. The process of claim 8 wherein the C₈₋₂₀ bis-isocyanates comprises toluene diisocyanate, bis(4-isocyanatocyclohexyl)methane.

12. The process of claim 1 wherein the guanidine compound is added from 10 to 50 equivalent % of the at least one first prepolymer.
